(19) United States
(12) Patent Application Publication
(10) Pub. No.: US 2023/0296468 A1
(43) Pub. Date: Sep. 21, 2023

(54) DUAL MODE FUEL TANK LEAKAGE DETECTOR

(71) Applicants: KABIR BHANDARI, NEW DELHI (IN); AMARDIP KUMAR, GURGAON (IN); KUMAR ABHISHEK, Gurgaon (IN); ABHIJATYA GUPTA, Gurgaon (IN)

(72) Inventors: KABIR BHANDARI, NEW DELHI (IN); AMARDIP KUMAR, GURGAON (IN); KUMAR ABHISHEK, Gurgaon (IN); ABHIJATYA GUPTA, Gurgaon (IN)

(21) Appl. No.: 17/696,908

(22) Filed: Mar. 17, 2022

(51) Int. Cl. G01M 3/32; B60K 15/03

(52) U.S. Cl. CPC G01M 3/3209; B60K 15/03; B60K 2015/0321; B60K 2015/03243; B60K 2015/03256

(57) ABSTRACT

The present invention discloses a dual mode fuel tank leakage detector (100), comprising of an electromechanical valve (1) with a canister port, an engine control unit, pump assembly, a sensor (3) and works in pressure condition by comparing a measured pressure with reference pressure; in case there is leakage then the pressure is not upto the reference pressure within time interval. In case of no leakage, the pressure will be equal/above than the reference pressure, the leakage detector (100) works in vacuum condition by comparing a measured leakage with a reference leakage, in case there is a leakage the measured vacuum is not able to reach to the reference vacuum within a time interval and when there is no leakage, the measured vacuum will be equal or above from the reference vacuum and fuel tank leakage detector (100) enables to monitor leakage detection either in vacuum or pressure conditions.

### FIELD OF THE INVENTION

The present invention relates to leakage detector for detecting fuel vapor leakage from fuel tank. More particularly the present invention pertains to a dual mode fuel tank leakage detector that works both in pressure as well as vacuum conditions with the same motor pump assembly and enables the engine control unit to monitor precise leakage detection either in vacuum or pressure conditions cost effectively.

### BACKGROUND OF THE INVENTION

In mechanical devices and systems, leakage occur through a crack or hole in an enveloping wall or joint that allows different fluids and gases to escape from a closed medium. Majorly leakage test procedure is a quality control step to confirm the device integrity and is a one-time non-destructive test. The foremost purpose of leakage detection is to detect the leakage by localizing and measuring the size of leakage in sealed devices and system.

A functional pressure leak detector is an integrated pump and is essential to keep interstitial space at high pressure. The pressure level in the interstitial space should remain higher than the maximum hydrostatical or operating pressure in the tank as this overpressure in the interstitial space prevents the liquid to enter the environment. Maintaining high pressure in the interstitial space helps during the leakage in the wall tank. During a leakage in the tank wall, above or below the liquid level in the tank, overpressure escapes from the interstitial space and at higher leakages, the pressure level in the interstitial space decreases slowly thereby indicated through the alarm. The difference in the interstitial space or very small leakages caused due to various factors such as changes in temperature can be compensated by an integrated pump.

A functional vacuum leak detector with integrated pump works by maintaining vacuum level in the interstitial space that prevents the liquid to enter the environment. Pursuant to that, the vacuum level in the interstitial space is maintained at a higher pressure level than the maximum hydrostatical pressure inside the tank. A high level of vacuum enables the air or stored liquid sucked into the interstitial space during any leakage in the tank wall, above or below the liquid level in the tank. At higher leakages, the pressure level in the interstitial space decreases slowly thereby indicated through the alarm.

But the main drawback in leakage detection is that the current techniques, systems and devices available in the market increases the overall cost, moreover separate leakage systems are needed according to vacuum and pressure conditions due to which separate pump assembly is also needed that upsurges the cost. There is no integrated solution available in market for leakage detection.

US20120240664 discloses a fuel vapor leak detection device for detecting a leakage of fuel vapor includes a pump which pressurizes or depressurizes insides of a fuel tank and a canister, a motor which drives the pump, an electrical current detector which detects a current value applied to the motor, a switching valve, and a controller. The switching valve includes an air passage having a narrowing part therein and communicating with atmosphere, a first passage connecting to the pump, a canister connection passage connecting to the canister, and a second passage connecting to the pump. But this invention lacks in providing detecting technique that works both in pressure as well as vacuum conditions with the same motor pump assembly and enables the engine control unit to monitor precise leakage detection either in vacuum or pressure conditions cost effectively. Moreover, this invention has two aspects of leak detection devices i.e. electric current detector and pressure detector therefore this invention does not work in the vacuum condition.

US20140102421 discloses a fuel vapor leakage detection device performs a fuel vapor leakage detection method to detect a clogging of passages in an evaporated fuel processing system by (i) switching a switching valve after measuring a first reference pressure, (ii) determining whether a detected pressure equals atmospheric pressure after opening a purge valve, (iii) recording the detected pressure after closing the purge valve, and (iv) switching the switching valve to depressurize an atmospheric system and to determine whether a current detection value of the pressure sensor is the same as the first reference pressure. But this invention is not able to work well in both pressure as well as vacuum conditions without increasing the cost.

Therefore, there is a need of a fuel tank leakage detector that works both in pressure as well as vacuum conditions as per the requirement and enables the engine control unit to monitor precise leakage detection either in vacuum or pressure conditions with the same motor pump arrangement without an increase in cost.

### OBJECT OF THE INVENTION

The main object of the present invention is to provide a dual mode fuel tank leakage detector for detecting fuel vapor leakage from fuel tank.

Another object of the present invention is to provide a fuel tank leakage detector that works both in pressure as well as vacuum conditions according to requirement.

Yet another object of the present invention is to provide a fuel tank leakage detector enables the engine control unit to monitor precise leakage detection.

Yet another object of the present invention is to provide a fuel tank leakage detector that eliminates the urge to replace motor pump assembly arrangement.

Still another object of the present invention is to provide a fuel tank leakage detector that has improved flexibility.

### SUMMARY OF THE INVENTION

The present invention relates to a dual mode fuel tank leakage detector that provides high flexibility and works both on pressure as well as vacuum and permits the engine control unit to observe accurate leakage discernment.

In an embodiment, the present invention provides a dual mode fuel tank leakage detector, comprising of an upper housing and a lower housing having an electromechanical valve with a canister port, an engine control unit, pump assembly, a sensor, the electromechanical valve opens and closes the canister port according to signals provided by the engine control unit, wherein the pump assembly includes a pump preferably a vane type pump mounted on shaft of a motor for giving rotational input and the sensor is an integrated pressure sensor to sense the pressured of a fuel tank of a vehicle.

In another embodiment, the present invention provides a dual mode fuel tank leakage detector comprising of an electromechanical valve with a canister port, an engine control unit, pump assembly, a sensor that works in pressure condition by sending fresh air from atmosphere to a fuel tank of a vehicle that passes through a canister and an isolation valve in inactive condition, whereas in active condition, the pump permits the air to reach to the fuel tank by passing through a orifice due to which pressure in passage of the pump becomes constant after a time interval and that constant pressure is taken as reference pressure. The electromechanical valve starts and permits air flow from the orifice and a solenoid port towards the canister, in case there is leakage then the pressure is not up to the reference pressure within the time interval. In case of no leakage or permissible leakage, the pressure is equal or above than the reference pressure within the time interval respectively.

In another embodiment, the present invention provides a dual mode fuel tank leakage detector comprising of an electromechanical valve with a canister port, an engine control unit, pump assembly, a sensor that works in vacuum condition by reversing direction of a motor by the help of engine control unit by a printed circuit board that interchanges ports of the pump included in the pump assembly, when the pump is in active condition, a vacuum is created in the passage of the pump and that vacuum is sensed by the pressure sensor and considered as reference vacuum, the electromechanical valve in active state permits flow passage through the solenoid port, in case there is a leakage the measured vacuum does not reach to the reference vacuum within a time interval and when there is no leakage, the measured vacuum is equal or above from the reference vacuum within the time interval. Hence, the present invention enables working on both the modes i.e. pressure as well as vacuum conditions with the same pump assembly.

The above objects and advantages of the present invention will become apparent from the hereinafter set forth brief description of the drawings, detailed description of the invention, and claims appended herewith.

### BRIEF DESCRIPTION OF THE DRAWINGS

An understanding of the fuel tank leakage detector of the present invention may be obtained by reference to the following drawings:

FIG. 1 is a perspective view of the fuel tank leakage detector according to an embodiment of the present invention.

### DETAILED DESCRIPTION OF THE INVENTION

The present invention will now be described hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art.

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

The present invention provides a dual mode fuel tank leakage detector with high flexibility and allows working in dual modes i.e. in pressure as well as vacuum conditions according to requirement without increasing the overall cost.

In main embodiment, present invention provides a dual mode fuel tank leakage detector, comprising of an electromechanical valve with a canister port, an engine control unit, pump assembly, a sensor, the electromechanical valve opens and closes the canister port according to signals provided by the engine control unit, wherein the pump assembly includes a pump preferably a vane type pump mounted on shaft of a motor for giving rotational input and the sensor is an integrated pressure sensor to sense the pressured of a fuel tank of a vehicle. The fuel tank leakage detector works in pressure condition by sending fresh air from atmosphere to a fuel tank of a vehicle that passes through a canister and an isolation valve in inactive condition, whereas in active condition, the pump permits the air to reach to the fuel tank by passing through an orifice due to which pressure in passage of the pump becomes constant after a time interval and that constant pressure is taken as reference pressure. The electromechanical valve starts and permits air flow from the orifice and a solenoid port towards the canister, in case there is leakage then the pressure is not up to the reference pressure within the time interval. In case of no leakage or permissible leakage, the pressure is equal or above than the reference pressure within the time interval respectively and the fuel tank leakage detector works in vacuum condition by reversing direction of a motor by the help of engine control unit by a printed circuit board that interchanges ports of the pump included in the pump assembly, when the pump is in active condition, a vacuum is created in the passage of the pump and that vacuum is sensed by the pressure sensor and considered as reference vacuum, the electromechanical valve in active state permits flow passage through the solenoid port, in case there is a leakage the measured vacuum does not reach to the reference vacuum within a time interval and when there is no leakage, the measured vacuum is equal or above from the reference vacuum within the time interval.

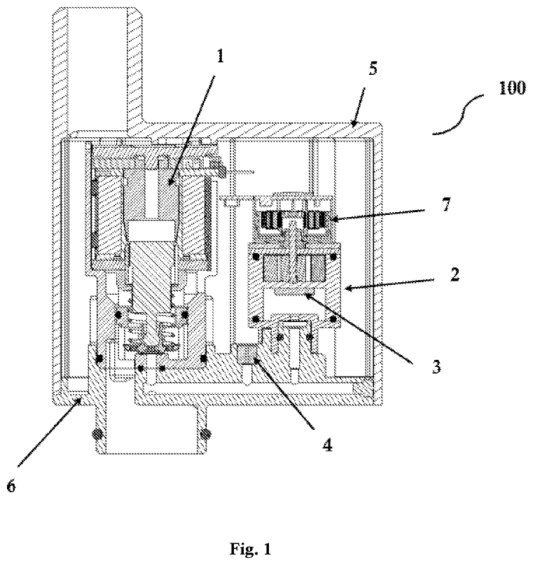

Referring to FIG. 1 a perspective view of the fuel tank leakage detector (100) is illustrated, that comprise of an upper housing (5), a lower housing (6) having electromechanical valve (1), a pump assembly, a pressure sensor (3). The electromechanical valve (1) is preferably a switchover valve that handles the opening and closing operations of a canister port as per feedback signals from engine control unit. The pump assembly includes a pump (2) and a motor (7), the pump (2) is preferably a vane type pump that is mounted on shaft of the motor (7) for providing rotational input for the pump (2), moreover the motor (7) used herein is a brushless direct current electric motor. The pressure sensor (3) is an integrated pressure sensor for sensing pressure built up inside fuel tank.

In pressure condition, fresh air is from atmosphere is passed through fuel tank of a vehicle that flows through a canister and an isolation valve in inactive state, whereas in active state, the pump (2) permits the air to reach to the fuel tank by flowing through an orifice (4) due to which pressure in passage of the pump (2) becomes constant after a time interval and that constant pressure is considered as a reference pressure. The orifice (4) used herein has diameter ranging from 0.5 mm to 0.10 mm.

The electromechanical valve (1) starts and allows air flow from the orifice (4) and a solenoid port towards the canister, if the pressure is not up to the reference pressure within the time interval, then there is leakage, whereas if the pressure is equal or above than the reference pressure within the time interval then there is no leakage or permissible leakage.

In vacuum condition, direction of the motor is reversed by the help of engine control unit by a printed circuit board that interchanges ports of the pump (2) included in the pump assembly, when the pump (2) is in active state, a vacuum is created in the passage of the pump and that vacuum is sensed by the pressure sensor and considered as reference vacuum, the electromechanical valve (1) in active state permits flow passage through the solenoid port, in case there is a leakage the measured vacuum is not able to reach to the reference vacuum within a time interval and when there is no leakage, the measured vacuum will be equal or above from the reference vacuum within the time interval.

Therefore, the present invention provides a fuel tank leakage detector enable engine control unit to monitor accurate leakage detection either in vacuum or pressure conditions with the same pump assembly without an increase in the total cost and provides high flexibility.

Many modifications and other embodiments of the invention set forth herein will readily occur to one skilled in the art to which the invention pertain having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

We claim:

1. A dual mode fuel tank leakage detector (100) comprising:
an upper housing (5) and a lower housing (6) having an electromechanical valve (1) with a canister port, an engine control unit, pump assembly, a sensor,
wherein,
the pump assembly includes a pump (2) mounted on shaft of a motor (7) for giving rotational input;
the fuel tank leakage detector (100) works in pressure condition by sending fresh air from atmosphere to a fuel tank that passes through a canister and an isolation valve in inactive condition;
the pump (2) in active condition permits the air to reach to the fuel tank by passing through an orifice (4) due to which pressure in passage of the pump becomes constant after a time interval and that constant pressure is taken as reference pressure;
said sensor works in vacuum condition by reversing the direction of a motor (7) through engine control unit that interchanges ports of the pump (2) in the pump assembly;
the electromechanical valve starts and permits air flow from the pump (2) to fuel tank and from a solenoid port towards the canister port and the pressure does not reach upto a reference pressure within a time interval in case of leakage; and
the pressure is equal or above the reference pressure when there is no leakage and the fuel tank leakage detector (100) works in vacuum condition by reversing direction of a motor (7).

2. The dual mode fuel tank leakage detector as claimed in claim 1, wherein the electromechanical valve opens and closes the canister port according to signals provided by the engine control unit.

3. The dual mode fuel tank leakage detector as claimed in claim 1, wherein the pump (2) is preferably a vane type pump.

4. The dual mode fuel tank leakage detector as claimed in claim 1, wherein the sensor is an integrated pressure sensor (3) to sense the pressured of a fuel tank of a vehicle.

5. The dual mode fuel tank leakage detector as claimed in claim 1, wherein the motor (7) herein is a brushless direct current electric motor.

6. The dual mode fuel tank leakage detector as claimed in claim 1, wherein the orifice (4) is having a diameter ranging from 0.5 mm to 0.10 mm.
